(19) United States
(12) Patent Application Publication
(10) Pub. No.: US 2009/0310336 A1
(43) Pub. Date: Dec. 17, 2009

(54) LIGHT GUIDE PLATE AND BACKLIGHT ASSEMBLY HAVING THE SAME

(76) Inventors: Byung-Seo YOON, Dong-gu (KR); In-Sun HWANG, Suwon Si (KR); Heu-Gon KIM, Yongin-si (KR); Moon-Hwan CHANG, Yongin-si (KR); Taek-Sun SHIN, Asan-si (KR)

Correspondence Address: Haynes and Boone, LLP;IP Section, 2323 Victory Avenue, SUITE 700, Dallas, TX, 75219, US

(21) Appl. No.: 12/392,008

(22) Filed: Feb. 24, 2009

(30) Foreign Application Priority Data
Jun. 17, 2008 (KR) 10-2008-0056903

(51) Int. Cl. G02B 6/00; F21V 8/00

(52) U.S. Cl. 362/97.1; 362/327

(57) ABSTRACT

In a light guide plate and a backlight assembly having the same, the light guide plate includes a plurality of light guide cells. Each light guide cell has at least one incident surface that receives light from an outside light source. The incident surfaces of the light guide cells are arranged in non-parallel planes. A light source unit includes at least one light source adjacent to the incident surface of each light guide cell. Thus, brightness of the backlight assembly is improved and thickness of the backlight assembly is reduced.

### CROSS-REFERENCE TO RELATED APPLICATION

This application relies for priority upon Korean Patent Application No. 2008-56903 filed on Jun. 17, 2008, the contents of which are herein incorporated by reference in their entirety.

### BACKGROUND

1. Field of the Invention

The present invention relates to a light guide plate and a backlight assembly having the same. More particularly, the present invention relates to a light guide plate capable of reducing thickness of the backlight assembly and a backlight assembly incorporating the light guide plate.

2. Description of the Related Art

In general, a liquid crystal display (LCD) displays images by using optical characteristics of liquid crystal. Since the LCD uses liquid crystals, which are not self-emissive in themselves, a backlight assembly is positioned behind a liquid crystal display panel to provide light to the liquid crystal display panel. The liquid crystal display panel displays images using the light from the backlight assembly.

The back light assembly is classified into a direct-illumination type backlight assembly and an edge-illumination type backlight assembly according to the position of a light source. The direct-illumination type backlight assembly provides light to the liquid crystal display panel by using a light source installed below the liquid crystal display panel. The edge-illumination type backlight assembly usually has a light source positioned next to a light element, such as a light guiding plate. The direct-illumination type backlight assembly may include a plurality of light sources. For this reason, the direct-illumination type backlight assembly may be capable of providing higher brightness as compared with the edge-illumination type backlight assembly.

However, in the direct-illumination type backlight assembly, a certain distance between light sources and between the liquid crystal display panel and the light source is maintained to prevent brightness from being lowered. For this reason, the thickness of the direct-illumination type backlight assembly is larger than that of the edge-illumination type backlight assembly.

The edge-illumination type backlight assembly has smaller thickness, but the number of light sources that can be used with this configuration is limited as compared with that of the direct-illumination type backlight assembly. For this reason, the edge-illumination type backlight assembly may not be suitable for a large-size LCD.

### SUMMARY

The present invention provides a light guide plate capable of improving the brightness of a backlight assembly while reducing the thickness of the backlight assembly.

The present invention also provides a backlight assembly that employs the light guide plate to improve brightness and reduce the thickness.

In one aspect of the present invention, a light guide plate includes a plurality of light guide cells. Each light guide cell has at least one incident surface that receives light from outside the light guide cell. The incident surfaces of the light guide cells are arranged in non-parallel planes.

In another exemplary embodiment of the present invention, a backlight assembly includes a light guide plate and a light source unit. The light guide plate includes a plurality of light guide cells, which are integrally connected to each other and each light guide cell has at least one incident surface that receives a light. The light source unit includes at least one light source adjacent to the incident surface of each light guide cell. The incident surfaces of the light guide cells are arranged in non-parallel planes.

In yet another aspect, the invention is a light guide plate including a plurality of inclined structures arranged adjacent to one another, wherein each of triangular inclined structures is tilted with respect to adjacent triangular inclined structures.

According to the above, the light guide plate includes a plurality of light guide cells and at least one light source is aligned at one side of each light guide cell, thereby improving brightness of the backlight assembly and reducing thickness of the backlight assembly.

### BRIEF DESCRIPTION OF THE DRAWINGS

The above and other advantages of the present invention will become readily apparent by reference to the following detailed description when considered in conjunction with the accompanying drawings, wherein:

FIG. 1 is a rear view showing an exemplary embodiment of a light guide plate according to the present invention;

FIG. 2 is a partially-enlarged perspective view of the light guide plate shown in FIG. 1;

FIG. 3 is a perspective view of a light guide cell shown in FIG. 1;

FIG. 4 is a side view of a light guide cell shown in FIG. 3;

FIG. 5 is a perspective view showing another exemplary embodiment of a light guide cell according to the present invention;

FIG. 6 is a sectional view showing an exemplary embodiment of a backlight assembly according to the present invention;

FIG. 7 is a sectional view showing another exemplary embodiment of a backlight assembly according to the present invention;

FIG. 8 is a sectional view showing another exemplary embodiment of a backlight assembly according to the present invention;

FIGS. 9A to 9C are views showing distribution of light output from a light guide cell;

FIG. 10 is a sectional view showing another exemplary embodiment of a backlight assembly according to the present invention;

FIG. 11 is a perspective view of a bottom chassis shown in FIG. 10;

FIG. 12 is a sectional view taken along line I-I′ shown in FIG. 11;

FIG. 13 is a plan view showing exemplary embodiments of flexible printed circuit boards according to the present invention; and

FIG. 14 is a plan view showing another exemplary embodiments of flexible printed circuit boards according to the present invention.

### DESCRIPTION OF THE EMBODIMENTS

Hereinafter, the present invention will be explained in detail with reference to the accompanying drawings.

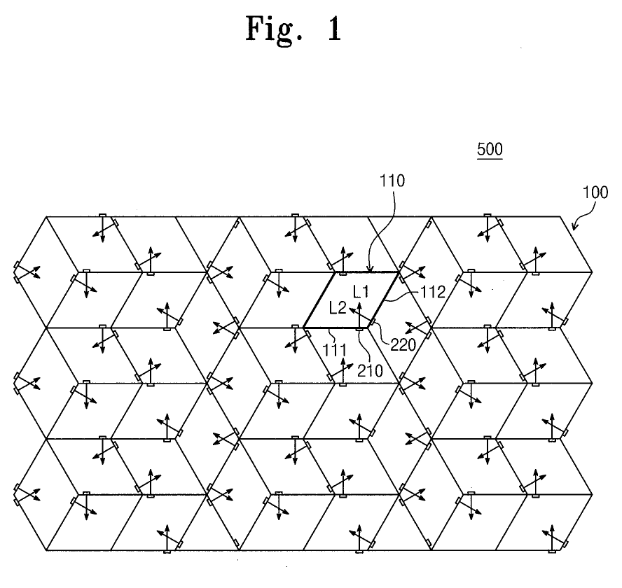

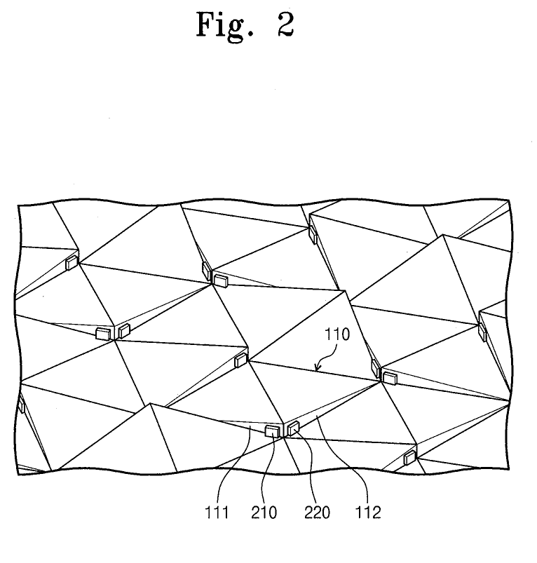

FIG. 1 is a rear view showing an exemplary embodiment of a light guide plate according to the present invention, and FIG. 2 is a partially-enlarged perspective view of the light guide plate shown in FIG. 1.

Referring to FIGS. 1 and 2, a backlight assembly 500 includes a light guide plate 100 and a plurality of light emitting diodes (LEDs) 210 and 220 installed at a rear surface of the light guide plate 100.

The light guide plate 100 includes a plurality of light guide cells 110 that are integrally formed with each other. Each light guide cell 110 includes first and second LEDs 210 and 220 that emit light in different directions. Each light guide cell 110 has first and second incident surfaces 111 and 112 to receive first and second lights L1 and L2 emitted from the first and second LEDs 210 and 220. The first and second incident surfaces 111 and 112 of the light guide cell 110 is offset from first and second incident surfaces of an adjacent light guide cell. Thus, the first and second lights L1 and L2 may not be concentrated on one spot in the light guide plate 100.

For instance, if the light guide cells 110 are positioned to form an angle with respect to each other in the light guide plate 100 as shown in FIG. 1, each light guide cell 110 receives first and second lights L1 and L2 that travel in the direction different from the first and second lights L1 and L2 that are incident on an adjacent light guide cell. Thus, light is not concentrated on one spot in the light guide plate 100, so that brightness uniformity of the light output from the backlight assembly 500 may be improved.

The light guide cells 110 of the light guide plate 100 have the same structure, so the following description will be made with reference to one light guide cell 110.

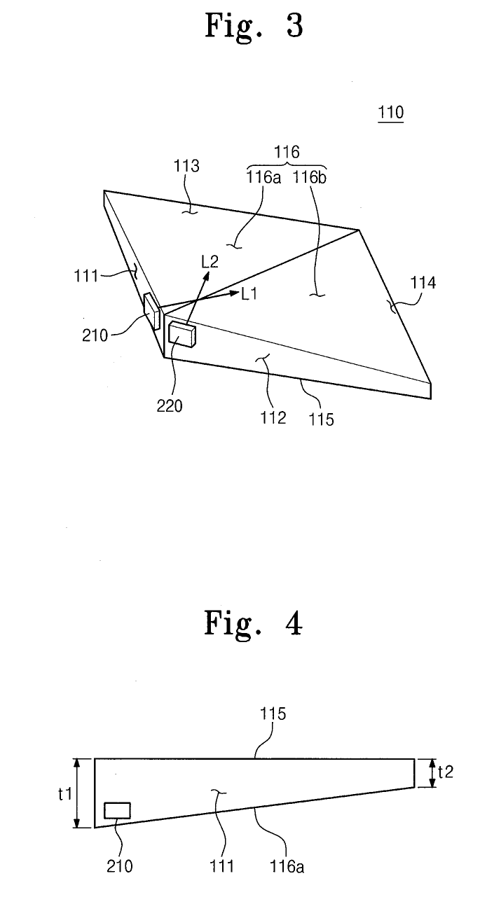

FIG. 3 is a perspective view of the light guide cell shown in FIG. 1, and FIG. 4 is a side view of the light guide cell shown in FIG. 3.

Referring to FIGS. 3 and 4, the light guide cell 110 includes a first incident surface 111, a second incident surface 112, a first side surface 113, a second side surface 114, an exit surface 115 and a reflective surface 116.

The first and second incident surfaces 111 and 112 receive lights L1 and L2 from the first and second LEDs 210 and 220, respectively. The first LED 210 is provided adjacent to a first end of the first incident surface 111 and the second LED 220 is provided adjacent to a first end of the second incident surface 112. The first end of the first incident surface 111 is connected to the first end of the second incident surface 112. In addition, the thickness of the first and second incident surfaces 111 and 112 changes (e.g., decreases in the exemplary case shown) going from the first end to the second end, which is opposite the first end.

Meanwhile, the first side surface 113 faces the second incident surface 112 and is connected to the second end of the first incident surface 111. The second side surface 114 faces the first incident surface 111 and is connected to the second end of the second incident surface 112. In the present exemplary embodiment of the present invention, the first side surface 113 has a thickness t2 corresponding to a half of a maximum thickness t1 of the first incident surface 111, and the second side surface 114 has a thickness t2 corresponding to a half of a maximum thickness t1 of the second incident surface 112.

The exit surface 115 interconnects the first and second incident surfaces 111 and 112, and the first and second side surfaces 113 and 114. The exit surface 115 has a planar structure to output the light. The reflective surface 116 faces the exit surface 115 and interconnects the first and second incident surfaces 111 and 112, and the first and second side surfaces 113 and 114. The reflective surface 116 includes a first reflective surface 116a connecting the first incident surface 111 to the first side surface 113, and a second reflective surface 116b adjacent to the first reflective surface 116a to connect the second incident surface 112 to the second side surface 114.

Since the thicknesses of the first and second incident surfaces 111 and 112 change with distance from the first ends, the first and second reflective surfaces 116a and 116b incline toward the exit surface 115 going from the first end to the second end. Thus, the first and second reflective surfaces 116a and 116b may effectively reflect the first and second lights L1 and L2, which are incident through the first and second incident surfaces 111 and 112, toward the exit surface 115. Further, since the first and second reflective surfaces 116a and 116b become closer to the exit surface 117 as the first and second reflective surfaces 116a and 116b are remote from the first and second LEDs 210 and 220, brightness degradation, which occurs at a region remote from the LEDs 210 and 220, can be prevented.

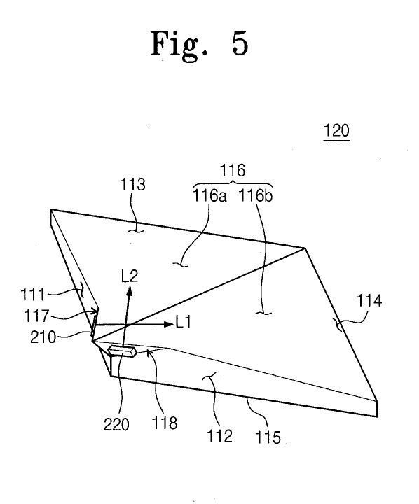

FIG. 5 is a perspective view showing another exemplary embodiment of a light guide cell according to the present invention. In FIG. 5, the same reference numerals will be assigned to elements identical to those of FIG. 3 and detailed description thereof will be omitted in order to avoid redundancy.

Referring to FIG. 5, first and second inclined surfaces 117 and 118 are formed at first ends of the first and second incident surfaces 111 and 112 while protruding outward from the first and second inclined surfaces 117 and 118, respectively.

The first inclined surface 117 forms an angle to the first incident surface 111 to guide the first light L1 of the first LED 210 toward the second side surface 114. The second inclined surface 118 is inclined relative to the second incident surface 112 to guide the second light L2 of the second LED 220 toward the first side surface 113.

As shown in FIG. 5, the first and second LEDs 210 and 220 are installed on the first and second inclined surfaces 117 and 118, respectively. The light path of the first and second lights L1 and L2 generated from the first and second LEDs 210 and 220 may be enlarged due to the first and second inclined surfaces 117 and 118. Thus, quantity of light supplied to an edge of the light guide cell 110 can be increased, so that the brightness of light output from the exit surface 115 can be improved.

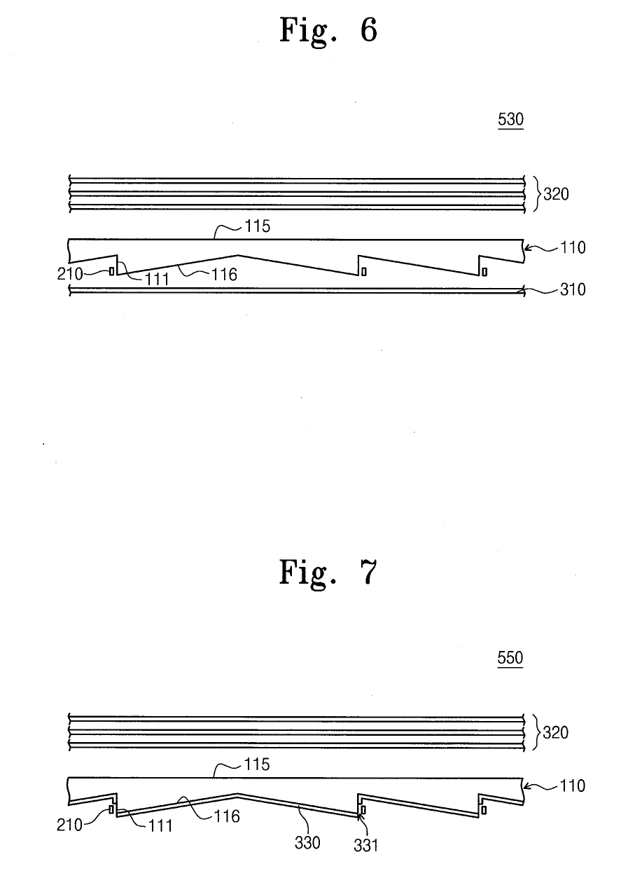

FIG. 6 is a sectional view showing an exemplary embodiment of a backlight assembly 530 according to the present invention.

Referring to FIG. 6, the backlight assembly 530 includes light guide cells 110, a plurality of LEDs 210, a reflective plate 310 and diffusion sheets 320.

The structure of the light guide cell 110 is identical to that of the light guide cell 110 shown in FIGS. 1 and 2, so detailed description thereof will be omitted.

The reflective plate 310 is provided below the light guide cell 110 while facing the reflective surface 116 of the light guide cell 110. The reflective plate 310 has a flat-plate structure and includes reflective material having high reflectivity, such as aluminum (Al). The reflective plate 310 sends the light that leaked from the reflective surface 116 of the light guide cell 110 to be incident on the light guide cell 110, thereby increasing the quantity of light output through the exit surface 115 of the light guide cell 110.

Meanwhile, the diffusion sheets 320 are provided above the light guide cell 110 to diffuse the light output through the exit surface 115 of the light guide cell 110. Thus, the brightness of the light output from the backlight assembly 530 can be improved due to the diffusion sheets 320.

FIG. 7 is a sectional view showing another exemplary embodiment of a backlight assembly 550 according to the present invention.

Referring to FIG. 7, the backlight assembly 550 includes a reflective plate 330 that is provided at a lower portion of the light guide cell 110 and has a shape identical to that of the light reflective surface 116 of the light guide cell 110. The reflective plate 330 is closely connected to the reflective surface 116 of the light guide cell 110 to reflect the light toward the light guide cell 110, which is leaked from the reflective surface 116.

Since the reflective plate 330 has substantially the same shape as the reflective surface 116, the distance between the reflective plate 330 and the reflective surface 116 can be reduced. Consequently, light loss that occurs at the interface between the reflective plate 330 and the reflective surface 116 can be reduced. As a result, light efficiency of the backlight assembly 550 can be improved.

As shown in FIG. 7, the reflective plate 330 has a plurality of openings 331 which are formed at a region where the LEDs 210 are installed. The light incident surface 111 of the light guide cell 110 is partially exposed through the openings 331, so that the light emitted from the LEDs 210 can be incident into the light guide cell 110 through the exposed incident surface 111.

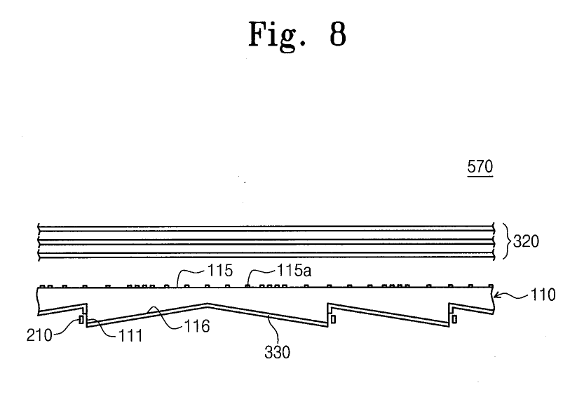

FIG. 8 is a sectional view showing another exemplary embodiment of a backlight assembly 570 according to the present invention.

Referring to FIG. 8, the backlight assembly 570 includes a light guide cell 110 having a diffusion pattern 115a formed on an exit surface 115. The diffusion pattern 115a diffuses the light that exits from the exit surface 115. The diffusion pattern 115a can be formed through a printing process applying diffusion ink to the exit surface 115 or a laser process irradiating laser on the exit surface 115.

The diffusion pattern 115a may be uniformly or irregularly distributed on the exit surface 115 according to quantity of light that exits the exit surface 115. When the diffusion pattern 115a is irregularly distributed on the exit surface 115, the diffusion pattern 115a is sparsely formed on a region where a greater amount of light is output, and the patterns are formed more closely to each other on a region where a smaller amount of light is output.

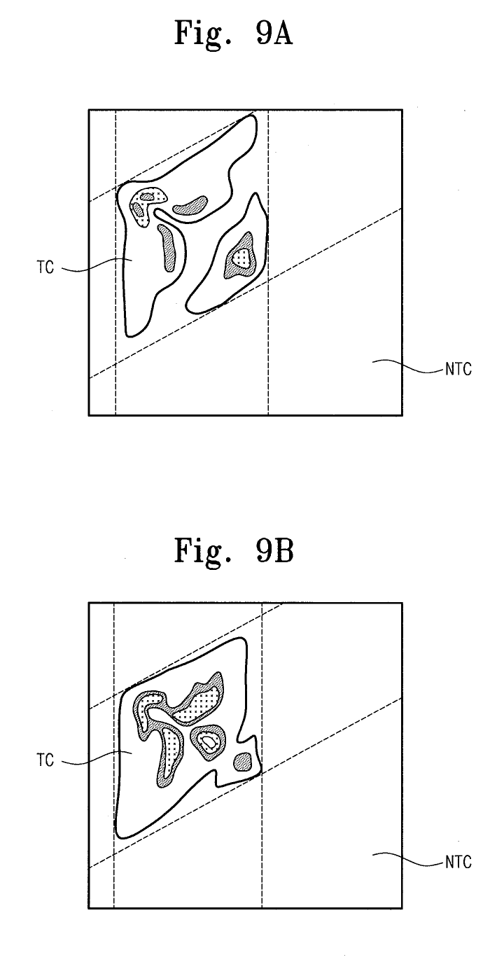

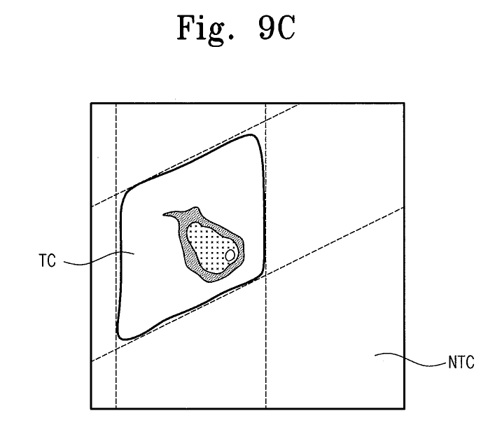

FIGS. 9A to 9C are views showing distribution of light output from the light guide cell. FIG. 9A shows light distribution when the diffusion pattern is not formed on the exit surface, FIG. 9B shows light distribution when the diffusion pattern is uniformly formed on the exit surface, and FIG. 9C shows light distribution when the diffusion pattern formed on the exit surface is adjusted according to the amount of light that is received on each portion. In FIGS. 9A to 9C, the light distribution is measured only at one light guide cell TC, and remaining light guide cells NTC adjacent to the light guide cell TC are in a dark state where the light is not supplied.

Referring to FIGS. 9A to 9C, the light distribution is more uniform when the diffusion pattern 115a is uniformly formed on the exit surface 115 than when the diffusion pattern 115a is not formed on the exit surface 115. In addition, the light distribution is more uniform when the density of the diffusion pattern 115a is adjusted according to quantity of light than when the diffusion pattern 115a is uniformly formed on the exit surface 115.

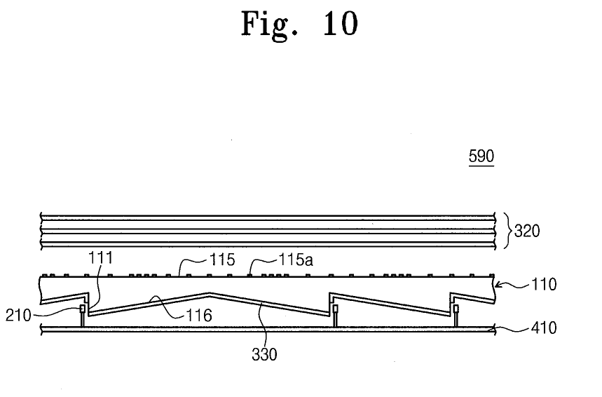

FIG. 10 is a sectional view showing an exemplary embodiment of a backlight assembly 590 according to the present invention.

Referring to FIG. 10, the backlight assembly 590 includes a circuit board 410 provided below the reflective plate 330. A plurality of LEDs 210 are mounted on the circuit board 410 and circuit interconnections (not shown) are formed on the circuit board 410 to supply power to the LEDs 210.

The circuit board 410 includes one of a printed circuit board, a bottom chassis, and a flexible printed circuit board.

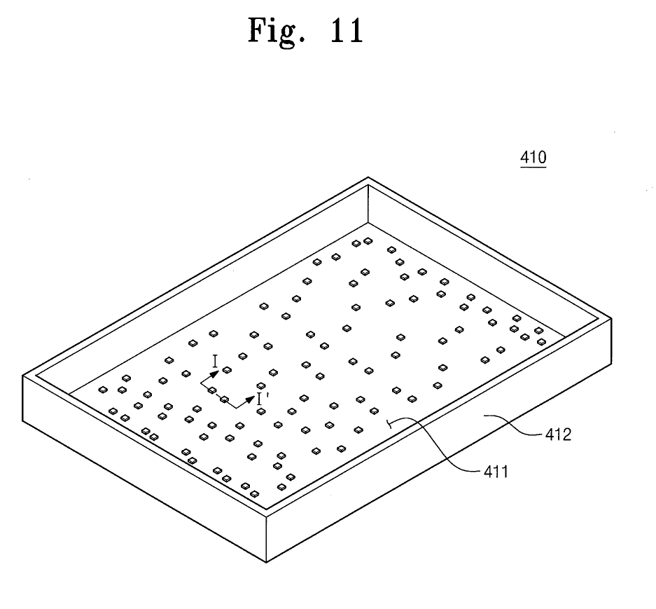

The circuit board 410 may also function as at least a portion of the bottom chassis in FIGS. 10 and 11.

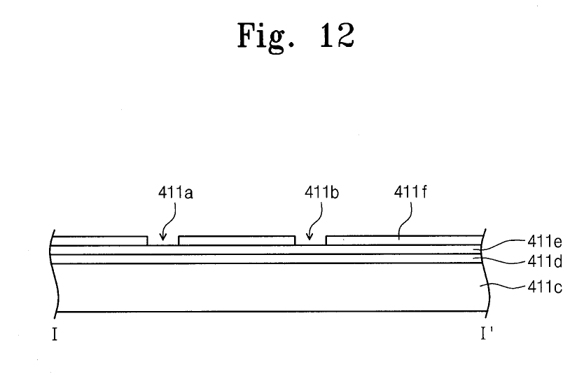

FIG. 11 is a perspective view of the bottom chassis 410 shown in FIG. 10, and FIG. 12 is a sectional view taken along line I-I′ shown in FIG. 11.

Referring to FIG. 11, the bottom chassis 410 is a container including a bottom surface 411, and sidewalls 412 extending from the bottom surface 411. The LEDs 210, the light guide cell 110, the reflective plate 330, and the diffusion sheets 320 shown in FIG. 10 are accommodated in a receiving cavity defined by the bottom surface 411 and the sidewalls 412.

The bottom surface 411 serves as a circuit board on which the LEDs 210 are mounted. In detail, as shown in FIG. 12, the bottom surface 411 includes a base substrate 411c, an insulating layer 411d, an interconnection 411e, and a coating layer 411f.

The base substrate 411c includes aluminum (Al), and the insulating layer 411d is coated on the base substrate 411c. Then, the interconnection 411e including copper (Cu) is formed on the insulating layer 411d. The interconnection 411e is covered with the coating layer 411f, and a plurality of holes 411a and 411b are formed in predetermined portions of the coating layer 411f where the LEDs 210 are mounted to expose the interconnection 411e.

Since the bottom surface 411 of the bottom chassis 410 serves as the circuit board to mount a plurality of LEDs 210 thereon, the thickness of the backlight assembly 590 can be reduced.

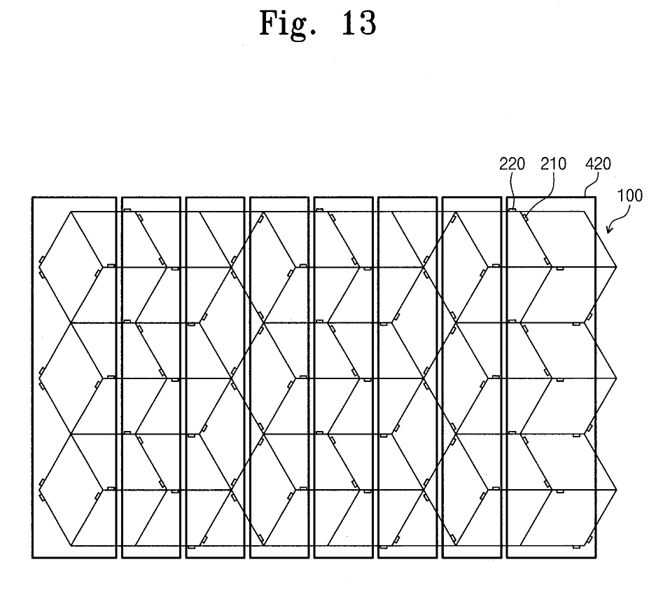

FIG. 13 is a plan view showing exemplary embodiments of a flexible printed circuit boards 420 according to the present invention.

Referring to FIG. 13, a plurality of flexible printed circuit boards 420 are arranged below a light guide plate 100 in a stripe pattern. First and second LEDs 210 and 220 are mounted on the flexible printed circuit board 420 at a lower portion of the light guide plate 100. Although not shown in the drawings, circuit interconnections are provided on the flexible printed circuit board 420 to supply power to the first and second LEDs 210 and 220. Upon receiving the power, the first and second LEDs 210 and 220 generate light to supply the light to the light guide plate 100.

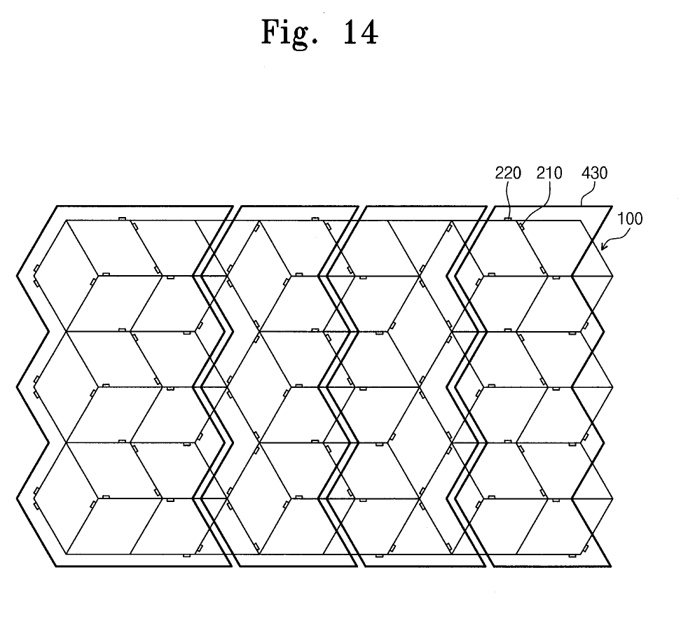

FIG. 14 is a plan view showing another exemplary embodiments of flexible printed circuit boards 430 according to the present invention.

Referring to FIG. 14, the flexible printed circuit boards 430 are arranged below the light guide plate 100 and have edges formed in a zigzag pattern. The light guide cells 110 of the light guide plate 100 are connected to each other such that first and second incident surfaces 111 and 112 are in non-parallel planes, so that the first and second LEDs 210 and 220 are irregularly arranged.

As shown in FIG. 14, the zigzag-patterned edges of the flexible printed circuit boards 430 allows more first and second LEDs 210 and 220 to be mounted on one flexible printed circuit board 430. As a result, the number of flexible printed circuit boards 430 that is used to mount the first and second LEDs 210 and 220 can be reduced in the backlight assembly.

According to the above, the light guide plate includes the light guide cells and at least one light source is aligned at one side of each light guide cell, thereby improving brightness of the backlight assembly and reducing thickness of the backlight assembly.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A light guide plate comprising:
a plurality of light guide cells,
wherein each light guide cell comprises at least one incident surface that receives light from outside the light guide cell and at least one side surface that opposites to the incident surfaces, and the incident surfaces of the light guide cells are arranged in at least two directions that are different from each other.

2. The light guide plate of claim 1, wherein each light guide cell comprises:
a first incident surface receiving a first light;
a second incident surface connected to the first incident surface to receive a second light;
a first side surface connected to the first incident surface while facing the second incident surface;
a second side surface connecting the second incident surface to the first side surface while facing the first incident surface;
an exit surface connected to the first and second incident surfaces and first and second side surfaces to output the first and second lights; and
a reflective surface connected to the first and second incident surfaces and first and second side surfaces while facing the exit surface to reflect the first and second lights toward the exit surface.

3. The light guide plate of claim 2, wherein thicknesses of the first and second incident surfaces change from first ends to second ends of the first and second incident surfaces, in which the first ends of first and second incident surfaces are connected to each other.

4. The light guide plate of claim 3, wherein the first and second side surfaces are connected to the second ends of the first and second incident surfaces, respectively.

5. The light guide plate of claim 3, wherein the exit surface has a planar structure and the reflective surface comprises:
a first reflective surface connecting the first incident surface to the first side surface while being inclined toward the first side surface; and
a second reflective surface, which connects the second incident surface to the second side surface and is connected to the first reflective surface while being inclined toward the second side surface.

6. The light guide plate of claim 2, further comprising a diffusion pattern formed on the exit surface to diffuse a light output from the exit surface.

7. A backlight assembly comprising:
a light guide plate comprising a plurality of light guide cells, each light guide cell having at least one incident surface that receives a light; and
a light source unit comprising at least one light source adjacent to the incident surface of each light guide cell,
wherein the incident surfaces of the light guide cells are arranged in non-parallel planes.

8. The backlight assembly of claim 7, wherein each light guide cell comprises:
a first incident surface receiving a first light;
a second incident surface connected to the first incident surface to receive a second light;
a first side surface connected to the first incident surface while facing the second incident surface;
a second side surface connecting the second incident surface to the first side surface while facing the first incident surface;
an exit surface connected to the first and second incident surfaces and first and second side surfaces to output the first and second lights; and
a reflective surface connected to the first and second incident surfaces and first and second side surfaces while facing the exit surface to reflect the first and second lights toward the exit surface.

9. The backlight assembly of claim 8, wherein thicknesses of the first and second incident surfaces change from first ends to second ends of the first and second incident surfaces, wherein the first ends of first and second incident surfaces touch each other.

10. The backlight assembly of claim 9, wherein the first and second side surfaces are connected to the second ends of the first and second incident surfaces, respectively.

11. The backlight assembly of claim 9, wherein the light source unit comprises:
a first light source adjacent to the first incident surface to generate a first light; and
a second light source adjacent to the second incident surface to generate a second light.

12. The backlight assembly of claim 11, wherein the first and second light sources comprise light emitting diodes installed adjacent to the first ends of the first and second incident surfaces, respectively.

13. The backlight assembly of claim 12, wherein each light guide cell comprises:
a first inclined surface protruding outward from the first incident surface to guide the first light of the first light source toward the second side surface; and
a second inclined surface protruding outward from the second incident surface to guide the second light of the second light source toward the first side surface.

14. The backlight assembly of claim 8, wherein the exit surface has a planar structure and the reflective surface comprises:
a first reflective surface connecting the first incident surface to the first side surface while being inclined toward the first side surface; and
a second reflective surface, which connects the second incident surface to the second side surface and is connected to the first reflective surface while being inclined toward the second side surface.

15. The backlight assembly of claim 14, further comprising a reflective plate installed below the reflective surface of the light guide plate, wherein the reflective plate has a flat structure.

16. The backlight assembly of claim 14, further comprising a reflective plate installed below the reflective surface of the light guide plate, wherein the reflective plate has a shape identical to a shape of the reflective surface.

17. The backlight assembly of claim 8, wherein the light guide plate comprises a diffusion pattern formed on the exit surface to diffuse a light output from the exit surface.

18. The backlight assembly of claim 7, further comprising a receiving container having a receiving cavity to accommodate the light guide plate and the light source unit therein, wherein at least one light source is mounted on a bottom surface of the receiving container.

19. The backlight assembly of claim 7, further comprising at least one flexible printed circuit board installed below the light guide plate to mount at least one light source thereon.

20. The backlight assembly of claim 19, wherein the at least one flexible printed circuit board is arranged in a stripe pattern.

21. The backlight assembly of claim 19, wherein the at least one flexible printed circuit board is arranged in a zigzag pattern.
